(19) United States
(12) Patent Application Publication
(10) Pub. No.: US 2026/0125329 A1
(43) Pub. Date: May 7, 2026

(54) EXTRACTION APPARATUS

(71) Applicant: Church Stewardship Inc., Rifton, NY (US)

(72) Inventors: Seth Conrad Swinger, Madisonville, TN (US); Nathanael Robert Clement, Madisonville, TN (US)

(21) Appl. No.: 19/381,146

(22) Filed: Nov. 6, 2025

Related U.S. Application Data
(60) Provisional application No. 63/717,557, filed on Nov. 7, 2024.

(51) Int. Cl. C05F 17/929; C05F 17/70; C05F 17/986

(52) U.S. Cl. CPC C05F 17/929; C05F 17/70; C05F 17/986

(57) ABSTRACT

In some aspects, the device includes a hopper for receiving compost, with a wide open upper end and a narrow closed lower end. A metering auger is mounted on a first portion of a shaft within the hopper's lower end, and an extraction auger is mounted on a second portion of the same shaft within an adjacent extraction chamber. The extraction chamber includes a tube screen assembly in fluid communication with the hopper and water spray nozzles that direct water onto compost conveyed from the hopper. As the shaft rotates, water washes beneficial materials from the compost, which are collected in a catch basin positioned below the extraction chamber. A drive assembly powers the shaft rotation. In certain embodiments, the apparatus is configured for continuous operation in irrigation pivot systems and can be calibrated based on standardized relationships among water flow rate, auger speed, and compost input weight.

### CROSS-REFERENCE

This application claims the benefit of U.S. Provisional Patent Application No. 63/717,557, filed Nov. 7, 2024, under 35 U.S.C. 119(e) which application is incorporated by reference herein in its entirety.

### FIELD

The present invention relates generally to extraction systems, and more particularly to an apparatus and associated methods for extracting biological materials and nutrients from compost or similar organic materials for use in soil amendment and microbial regeneration applications.

### BACKGROUND

Extraction is a process of selectively separating solid materials and transferring substances of interest into a liquid solution. Such processes are used in various applications, including the recovery of biology and nutrients from organic material for use as soil-building amendments that regenerate microbial ecosystems within soil profiles or on plant surfaces.

While extraction can be performed on a small scale using limited tools, specialized equipment is required to scale the process efficiently. Recent advances in microbial testing have revealed the complexity of microbiological communities within extracted liquids, emphasizing the importance of equipment capable of producing consistent, validated, and clean extracts.

Existing extraction equipment suffers from several drawbacks, including: inconsistent extraction quality and inefficient operation; limited cleanability, promoting the formation of biofilms that create anaerobic conditions conducive to pathogen growth; and difficult verification and maintenance procedures that lead to downtime and variability in extract quality.

Batch-style extraction systems, which typically use air and water agitation in large tanks, suffer from inefficiency, extended downtime, and poor cleanability. The introduction of air can also prematurely stimulate microbial reproduction, depleting dissolved oxygen and reducing the effective shelf life of the extract.

Continuous-flow extraction systems offer some improvement but often rely on multiple augers and power sources to handle material transport and extraction separately. Such systems are mechanically complex, costly, and prone to bridging and compaction within the hopper. Inaccessible nozzles and fixed covers further limit cleanability and visibility.

Accordingly, there exists a need for a simple, continuous extraction apparatus that is efficient, modular, easy to clean, and capable of producing consistent high-quality extracts.

In certain application, particularly agricultural irrigation systems such as center-pivot irrigation, a need exists for extraction equipment optimized for continuous operation in remote or semi-automated environments. Extractors installed near irrigation pivots must have larger hoppers, reinforced construction, and robust operation since they may be checked only periodically. Integrating the present design into such systems provides an automated, field-deployable source of biological extract directly into irrigation lines.

### SUMMARY

The present disclosure provides an extraction apparatus that integrates both metering and extraction functions into a single auger-driven assembly. The apparatus includes a hopper for receiving compost, a single shaft extending through the hopper and into an extraction chamber, and a screened enclosure housing spray nozzles along a hollow portion of the shaft.

As the shaft rotates, the metering auger portion conveys compost from the hopper into the extraction chamber, where the extraction auger portion agitates the compost while spray nozzles direct water against it through the surrounding screen. Biological material and nutrients are rinsed from the compost to form a liquid extract that passes through the screen and into a catch basin, while excess solid material is discharged downstream.

The invention improves upon prior systems by reducing mechanical complexity, enhancing cleanability, enabling tool-free screen replacement, and providing visibility into the extraction chamber. A single power input controls both metering and extraction, simplifying operation and maintenance while reducing cost.

In some embodiments, the extractor is configured for integration with irrigation pivot systems, enabling continuous extraction during irrigation. Such embodiments employ a larger-capacity hopper, weather-sealed enclosures, and durable drive systems capable of sustained operation with minimal operator intervention.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a schematic side view of the extraction apparatus of the present disclosure illustrating the single-shaft metering and extraction auger configuration;

FIG. 2A is a partial side view of the extraction apparatus showing the transparent removable lid and cutaway catch basin, and FIG. 2B is a side view of a cylindrical mesh screen that fits over the extraction auger during use;

FIG. 3 is a partial perspective view illustrating a tool-free mechanism for removal of the cylindrical mesh screen using swing-away centering mounts;

FIG. 4 is a top view of the hopper of the extraction apparatus showing the perforated side tubes used for water agitation;

FIG. 5A is a side view of the extraction apparatus of the extraction apparatus, showing the overall configuration and components thereof, and FIG. 5B provides a detailed close-up view of a portion of the extraction apparatus, highlighting the internal structure of the extraction chamber;

FIGS. 6A and 6B are front and rear views, respectively, of an embodiment of the extraction apparatus together show the positioning of the slip-clutch mechanism for an embodiment of the extraction apparatus;

FIG. 7 shows the details of the slip-clutch mechanism embodiment of the extraction apparatus;

FIG. 8 is a flowchart of a method of operating the extraction apparatus of the present disclosure; and

FIG. 9 is a flowchart of a method of calibrating the extraction apparatus of the present disclosure.

### DETAILED DESCRIPTION

In the present disclosure, like reference numbers refer to like elements throughout the drawings, which illustrate various exemplary embodiments of the present disclosure

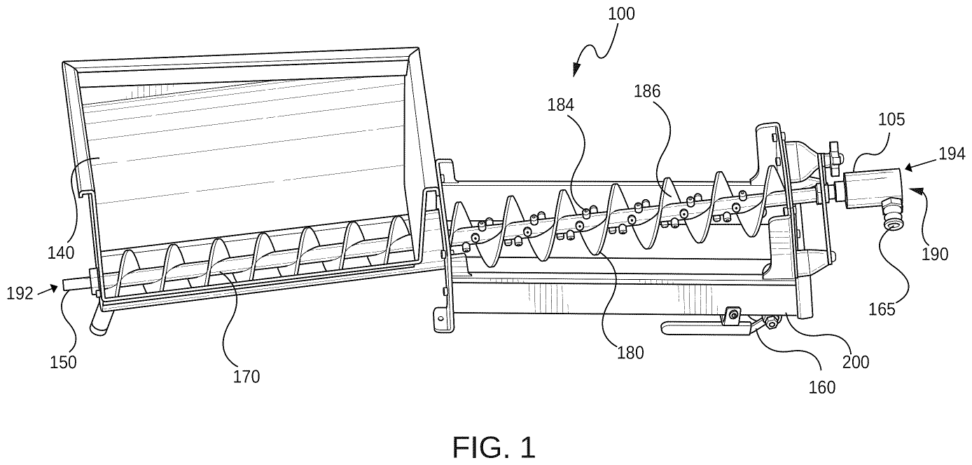

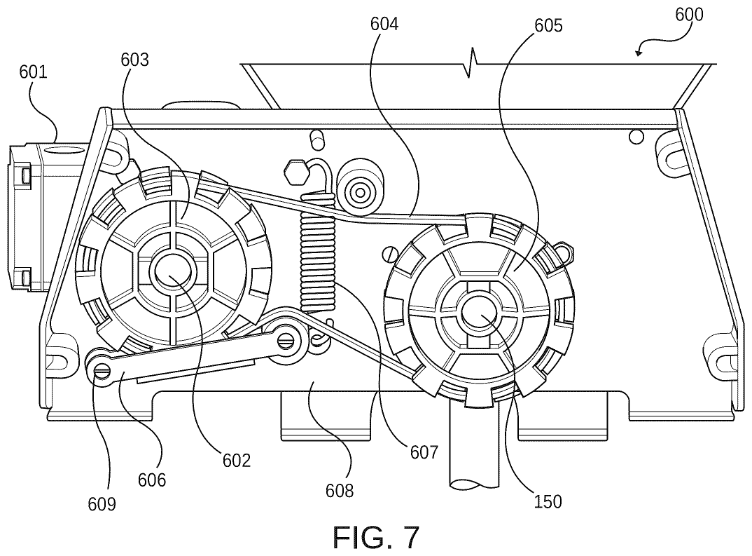

Referring to FIG. 1, the extraction apparatus 100 of the present disclosure includes a hopper 140 for receiving compost, a single rotating shaft 190 carrying both a metering auger 170 and an extraction auger 180, an extraction chamber 200 enclosed by a tube screen assembly, and a catch basin 120 positioned below the extraction chamber 200 to collect extract, which may be drained via an extract discharge port 160. The single rotating shaft 190 extends continuously from the hopper 140 through the extraction chamber 200. A first end 192 of the single rotating shaft 190 extends out of the hopper 140 to form a drive attachment 150. The metering auger 170 on the single rotating shaft 190 has a smaller diameter and/or a tighter pitch than the extraction auger 180 on the single rotating shaft 190. This ensures that material may be introduced from the hopper 140 into the extraction chamber 200 at a controlled rate to prevent overload. A single drive mechanism, which may be a manual crank or a motor, is attached to the drive attachment 150, either directly or indirectly as shown in FIG. 7 and discussed below. Any type of controlled motor may be used, including, for example, an electric motor, a gas motor, or an appropriate power tool such as an electric drill (corded or cordless). The use of a single drive mechanism provides for simultaneous control of both the metering and extraction operations. This means that a single variable, e.g., the rotational speed RPM of the single rotating shaft 190, governs both material flow and dilution ratio, simplifying operation and ensuring repeatability.

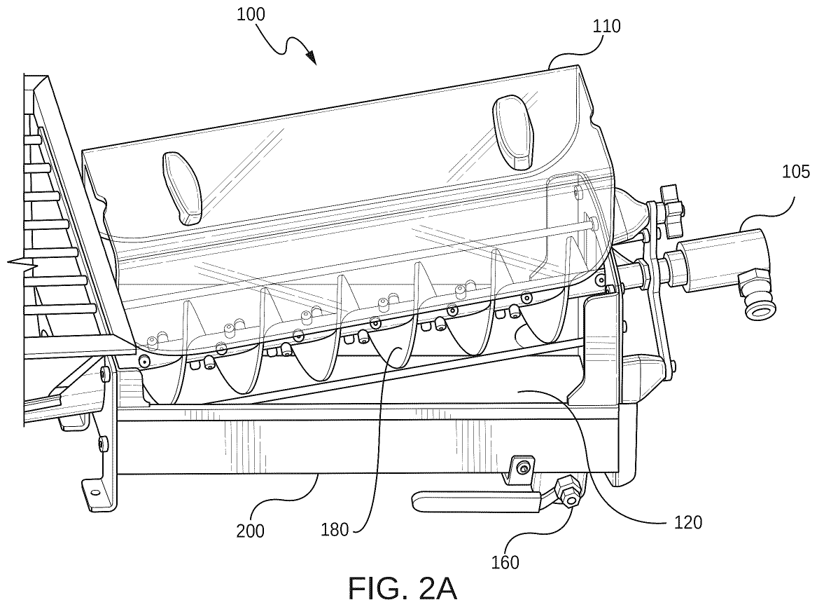

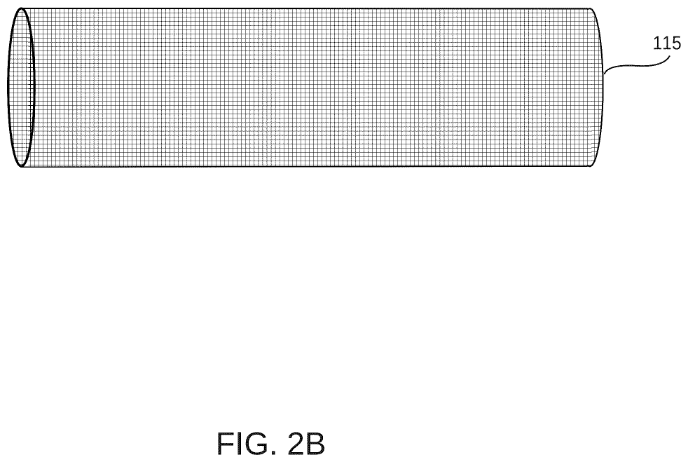

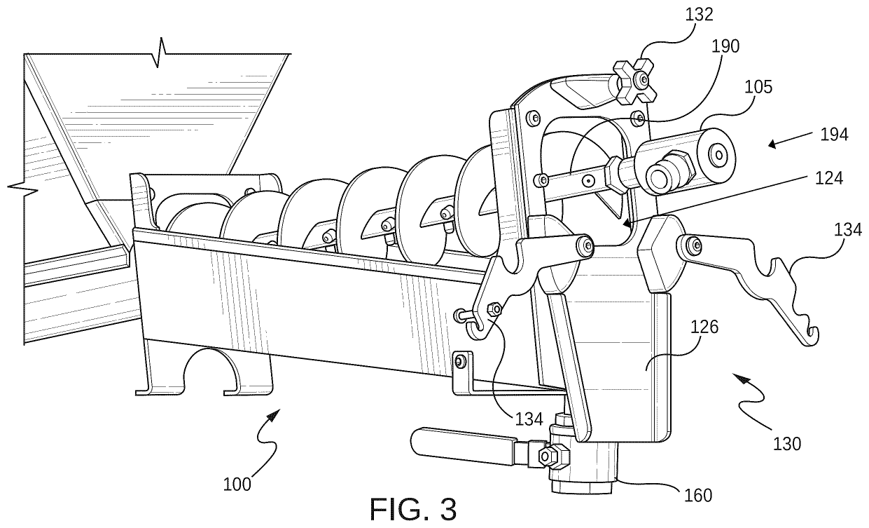

Referring now to FIGS. 2A and 2B, a removable lid 110, preferably transparent, provides visibility and tool-free access for cleaning within the extraction chamber 200. A cylindrical mesh screen 115 (shown in FIG. 2B) is positioned around the extraction auger 180 during use. A swivel union 105 is located at a second end 194 of the single rotating shaft 190 that is opposite the first end 192 thereof. The swivel union 105 is coupled to a water source (not shown) via an intake port 165 to supply pressurized water to a hollow portion of the single rotating shaft 190. This allows water to be distributed into the extraction chamber 200 via spray nozzles 184 positioned between auger flights 186. An opening 124 (shown in FIG. 3) at the second end of the single rotating shaft 190 allows the processed compost material to be expelled from the extraction chamber 200 and slide down a chute 126 for collection.

As shown in FIG. 3, a centering mount assembly 130 provided adjacent to the second end 194 of the single rotating shaft 190 includes two swing-away arms 134, 134 secured by a hand knob 132. Releasing the hand knob 132 allows the swing-away arms 134, 134 to pivot away from the hand knob 132 and the single rotating shaft 190, freeing a space to allow the cylindrical mesh screen 115 to be quickly removed or replaced without the need for any tools. During use, a cylindrical mesh screen 115 (like the cylindrical mesh screen 115 shown as an example in FIG. 2B) with a different screen mesh size may be installed depending on type of compost and the target extract characteristics. The removable lid 110 allows operators to visually inspect the extraction chamber 200 during operation, detect clogged spray tips, and monitor extract quality in real time, particularly when formed from a transparent material.

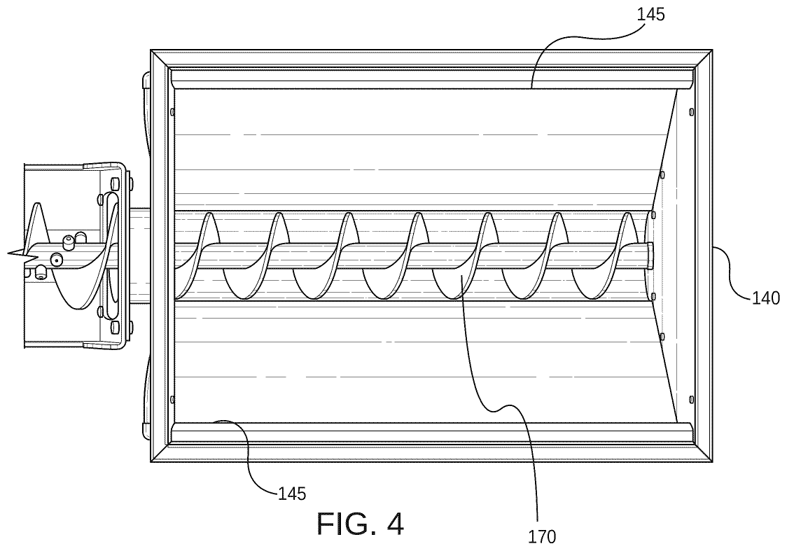

As shown in FIG. 4, the hopper 140 forms an internal chamber, with perforated tubes 145 preferably provided positioned along the upper edges of the hopper 140. The internal chamber is sized to hold an amount of material to be processed, in one example approximately 34 gallons of compost. The perforated tubes 145 introduce an adjustable water flow along an inner surface of the hopper 140 which reduces static friction and prevents bridging or compaction of compost material within the hopper 140. The introduction of water in the manner constitutes a hydraulic agitation method which eliminates any need for mechanical agitators, enhancing safety and reliability.

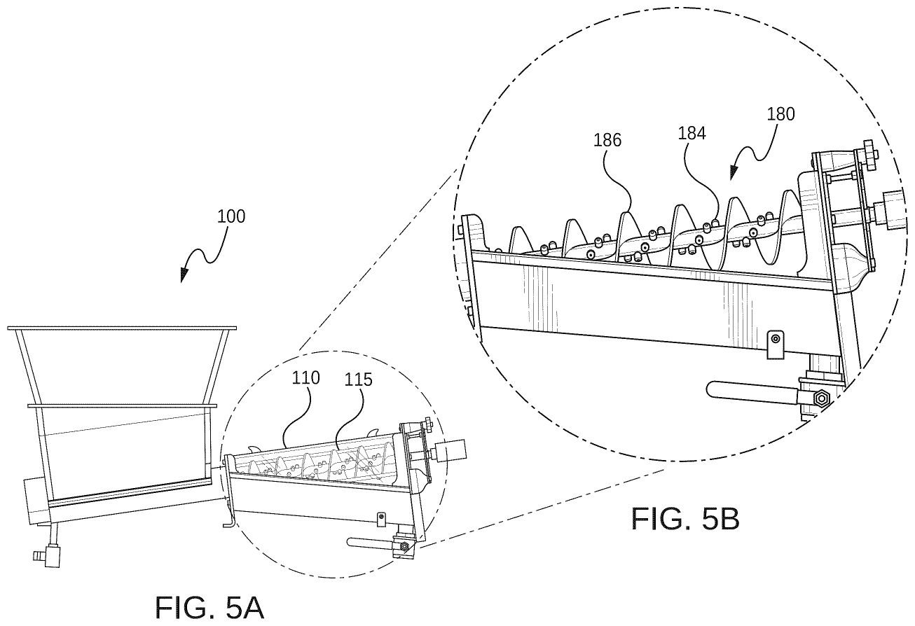

Referring now to FIGS. 5A and 5B, the position of the removable lid 110 and the cylindrical mesh screen 115 within the extraction apparatus 100 are shown in detail, along with details of the spray nozzles 184 and auger flights 186 on the extraction auger 180.

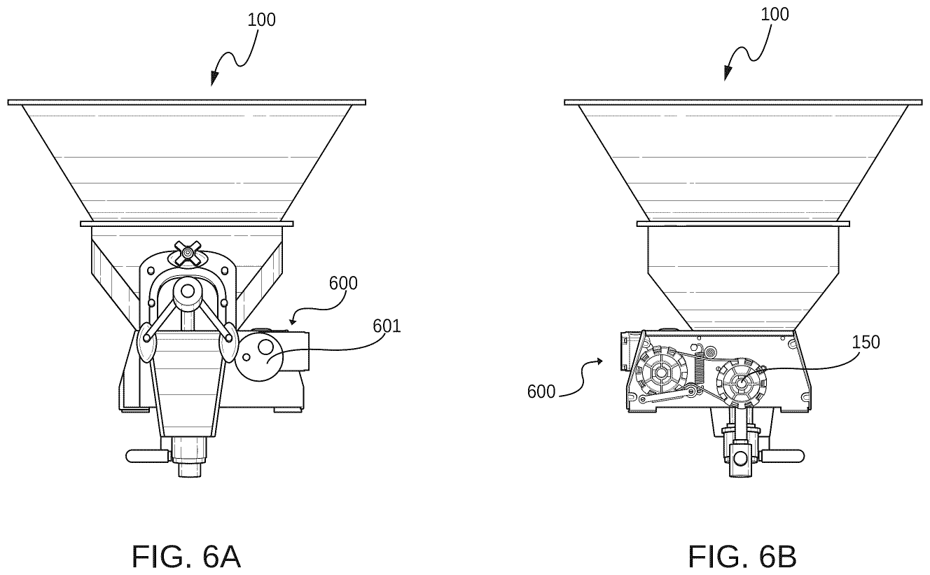

Referring now to FIGS. 6A and 6B, in one embodiment, an indirect drive assembly 600 including a motor 601 may be coupled to the drive attachment 150 to rotate the single rotating shaft 190 of the extraction apparatus 100. As shown in detail in FIG. 7, the indirect drive assembly 600 includes a first sprocket 605 attached to the drive attachment 150 and a second sprocket 603 attached to the shaft 602 of the motor 601. The first sprocket 605 and second sprocket 603 are coupled by a belt 604 which preferably includes a spring slip clutch mechanism formed from a spring 607 and a shaft 606. One end of the spring 607 is fixed and the other end is connected to a first end of the shaft 606. The second end of the shaft 606 is fixed and pivots with respect to the frame 608 of the indirect drive assembly 600 via a connection 609. In operation, when the motor torque exceeds a threshold controlled by the spring 607, the belt 604 releases and decouples the motor 601 from the drive attachment 150 and thus the single rotating shaft 190 in order to prevent motor burnout. This is useful to prevent motor damage when a foreign object jams the metering auger 170.

During operation, extract from the processed compost passes through the cylindrical mesh screen 115 and drains by gravity into the catch basin 120 and exits via the extract discharge port 160. The extract discharge port 160 may feed a pump or a receptacle for downstream processing. The extract discharge port 160 may also be coupled to a dosing or injection system for fertigation applications.

In one application, the extraction apparatus of the present disclosure may be adapted for installation near an irrigation pivot to enable continuous extraction concurrent with irrigation. This version may include, for example, an enlarged hopper to accommodate higher compost capacity for extended unattended operation; a reinforced, weather-resistant frame and sealed electronics; and a high-duty variable-speed motor rated for outdoor environments. This configuration allows the extractor to operate continuously and inject biologically rich extract directly into irrigation water, minimizing handling and improving field-level soil amendment.

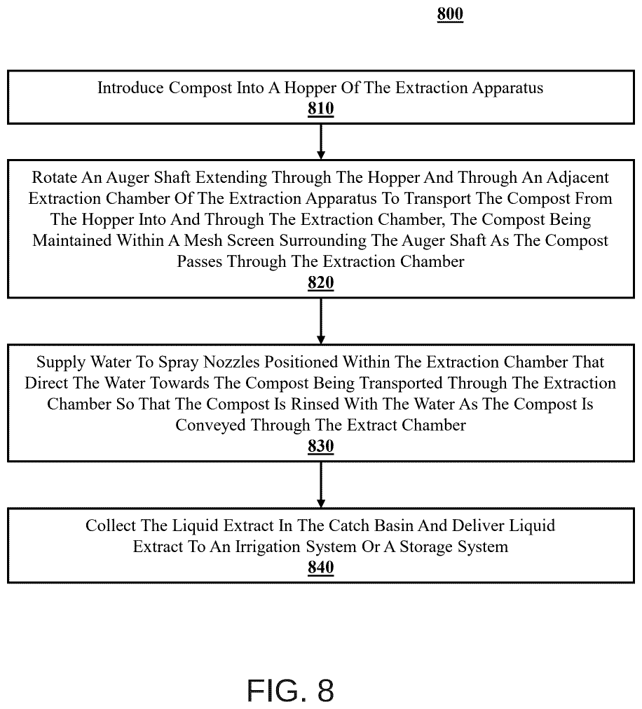

Referring now to FIG. 8, the present invention provides a method 800 of operating an extraction apparatus for producing a liquid extract from compost. The method begins at step 810 with the introduction of compost into a hopper located at the upper portion of the apparatus. An auger shaft, which extends through both the hopper and an adjacent extraction chamber, is then rotated at step 820 to transport the compost from the hopper into and through the extraction chamber. As the compost moves through the chamber, it is contained within a mesh screen that surrounds the auger shaft. This screen ensures the compost remains in proximity to the auger while permitting separation of liquid extract.

Water is supplied to spray nozzles positioned within the extraction chamber at step 830. These nozzles are oriented to direct the water toward the compost as it is conveyed by the auger. This configuration ensures that the compost is rinsed thoroughly with water during its passage, facilitating the release of soluble nutrients and other beneficial components into the water. The resulting liquid extract passes through the mesh screen and is collected at step 840 in a catch basin located beneath or adjacent to the extraction chamber.

In certain embodiments, the method may further include collecting the liquid extract from the catch basin and delivering it to an irrigation system for direct application to crops or, alternatively, transferring the extract to a storage system for later use or distribution.

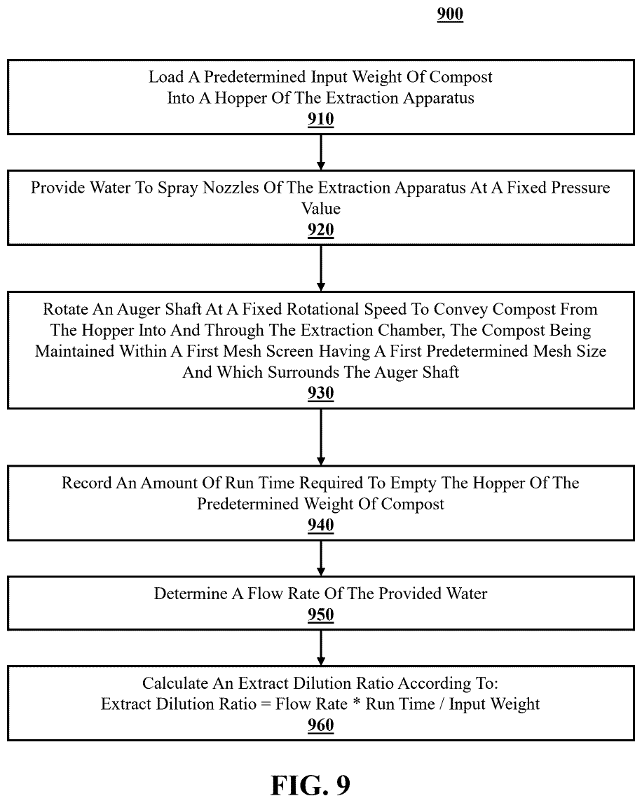

Referring now to FIG. 9, the present invention includes a method 900 for calibrating an extraction apparatus used to process compost and generate a liquid extract. The calibration procedure ensures that the apparatus can be configured to produce a consistent and controllable extract dilution ratio. The method begins at step 910 by loading a predetermined input weight of compost into the hopper of the extraction apparatus. This input weight is known and controlled, providing a baseline for measuring the output and process parameters.

Next, at step 920 water is supplied to spray nozzles located within the extraction apparatus. The water is delivered at a fixed pressure value, which contributes to the overall extraction and dilution process as the compost moves through the apparatus.

An auger shaft, which extends through both the hopper and an adjacent extraction chamber, is then rotated at a fixed rotational speed at step 930. This auger is responsible for conveying the compost from the hopper into and through the extraction chamber. During this transport, the compost is retained within a first mesh screen that surrounds the auger shaft. This screen has a predetermined mesh size and serves to regulate the consistency and flow characteristics of the compost as it is processed.

As the process continues, the amount of run time required to fully empty the hopper of the predetermined compost weight is recorded at step 940. Concurrently, the flow rate of the water provided to the spray nozzles is determined at step 950.

Using the recorded run time, water flow rate, and initial compost weight, an extract dilution ratio is calculated according to the following formula: Extract Dilution Ratio=Flow Rate*Run Time/Input Weight

This calculated ratio reflects the level of dilution achieved during the extraction process, and can be used to assess or adjust the operation of the apparatus. In further refinements of the method, the rotational speed of the auger shaft may be adjusted in order to achieve a desired extract dilution ratio. Likewise, the fixed water pressure may be modified to produce a similar effect on the dilution ratio. Additionally, the mesh screen surrounding the auger shaft can be replaced with an alternative screen having a different predetermined mesh size. Changing the mesh size influences how the compost interacts with the water during extraction, thereby allowing fine-tuning of the final dilution ratio. Control of auger speed, water pressure, and mesh screen selection allows the operator to fine-tune the extraction process to maintain consistent product quality. Calibration ensures a reliable baseline for repeatable extraction performance.

The disclosed extraction apparatus offers several notable advantages that improve both functionality and usability. One of the primary benefits is its continuous, single-shaft operation, which efficiently combines the metering and extraction processes into a streamlined, integrated system. This design not only simplifies control but also reduces overall power requirements, making the apparatus more energy-efficient and easier to operate.

Maintenance and cleaning are made significantly more convenient through tool-free access to internal components, allowing users to perform routine upkeep quickly and safely. In addition, the system enables visual monitoring of extraction conditions, giving operators real-time insight into the process for better control and quality assurance.

To accommodate varying filtration needs, the apparatus features quick-change mesh screens, which can be swapped out easily to adjust filtration levels as required. The modular design further enhances the apparatus by supporting scalability and customization, making it adaptable for different capacities and operational requirements.

Finally, an optional configuration allows the apparatus to be integrated into continuous-field operation within irrigation pivot systems, extending its utility for agricultural applications where direct extract delivery is desirable.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. An apparatus for extracting materials from compost, comprising:
a hopper for receiving compost, the hopper having a wide open upper end and a narrow closed lower end;
a metering auger mounted on a first part of a shaft within the narrow closed lower end of the hopper;
an extraction auger mounted on a second part of the shaft;
an extraction chamber positioned adjacent to the hopper, the extraction chamber having a tube screen assembly in open communication with the hopper and enclosing the extraction auger, the extraction chamber having water discharge spray nozzles for directing water onto compost being conveyed by the metering auger from the hopper into the extracting chamber by rotation of the shaft, the water directed onto the compost washing materials from the compost as the extraction auger rotates the compost received from the hopper;
a catch basin positioned below the extraction chamber to catch the materials washed from the compost; and
a drive assembly causing the rotation of the shaft.

2. The apparatus of claim 1, wherein the shaft has an inner hollow portion along a length of the extraction auger, wherein the water discharge spray nozzles are mounted on the extraction auger, and wherein the water is supplied to the water discharge spray nozzles through the inner hollow portion of the shaft.

3. The apparatus of claim 2, wherein the water is supplied to the water discharge spray nozzles through the inner hollow portion of the shaft via a swivel union connected to an end of the shaft proximal to the extraction auger.

4. The apparatus of claim 1, further comprising a lid positioned over the extraction chamber.

5. The apparatus of claim 1, wherein a portion of the shaft proximal to the extraction auger is mounted to an elongated outer wall of the catch assembly via a centering mount assembly.

6. The apparatus of claim 5, wherein the centering mount assembly has a first position in which the shaft is held in a fixed position two rotatable arms and a second position in which the two rotatable arms rotate to release the shaft.

7. The apparatus of claim 6, wherein the tube screen assembly is removable when the centering mount assembly is in the second position.

8. The apparatus of claim 1. wherein the hopper has perforated tubes along an upper portion of the wide open upper end for introducing water along an adjacent inner surface of the hopper to reduce static friction of the compost in the hopper.

9. The apparatus of claim 1. wherein the hopper has perforated tubes along two opposing upper edges of the wide open upper end for introducing water along an adjacent inner surface of the hopper to reduce static friction of the compost in the hopper.

10. The apparatus of claim 1, wherein the metering auger has helical portions of a first diameter, and wherein the extraction auger has helical portions of a second diameter, the second diameter larger than the first diameter.

11. The apparatus of claim 1, wherein the metering auger has helical portions of a first pitch, and wherein the extraction auger has helical portions of a second pitch, the second pitch larger than the first pitch.

12. The apparatus of claim 1, wherein the extraction chamber has an aperture adjacent to an end of the shaft proximal to the extraction auger for discharging compost after passing through the extraction chamber.

13. The apparatus of claim 1, wherein the shaft is inclined, with an end of the shaft proximal to the extraction auger positioned higher than an end of the shaft proximal to the metering auger.

14. The apparatus of claim 1, wherein the drive assembly comprises a hand crank coupled to an end of the shaft proximal to the metering auger.

15. The apparatus of claim 1, wherein the drive assembly comprises a motor coupled to an end of the shaft proximal to the metering auger.

16. The apparatus of claim 15, wherein the drive assembly includes a spring clutch mechanism coupled between the motor and the end of the shaft proximal to the metering auger; and wherein the spring clutch mechanism is configured to decouple the motor from the shaft when excessive torque is present on the shaft.

17. A method of operating an extraction apparatus, comprising:
a) introducing compost into a hopper of the extraction apparatus;
b) rotating an auger shaft extending through the hopper and through an adjacent extraction chamber of the extraction apparatus to transport the compost from the hopper into and through the extraction chamber, the compost being maintained within a mesh screen surrounding the auger shaft as the compost passes through the extraction chamber; and
c) supplying water to spray nozzles positioned within the extraction chamber, the spray nozzles directing the water towards the compost being transported through the extraction chamber so that the compost is rinsed with the water as the compost is conveyed through the extract chamber, thereby producing a liquid extract passing through the mesh screen surrounding the auger shaft and into a catch basin.

18. The method of claim 17, further comprising collecting the liquid extract in the catch basin and delivering liquid extract to an irrigation system or a storage system.

19. A method of calibrating an extraction apparatus, comprising:
a) loading a predetermined input weight of compost into a hopper of the extraction apparatus;
b) providing water to spray nozzles of the extraction apparatus at a fixed pressure value;
c) rotating an auger shaft extending through the hopper and through an adjacent extraction chamber of the extraction apparatus at a fixed rotational speed to convey the compost from the hopper into and through the extraction chamber, the compost being maintained within a first mesh screen surrounding the auger shaft as the compost passes through the extraction chamber, the first mesh screen having a first predetermined mesh size;
d) recording an amount of run time required to empty the hopper of the predetermined weight of compost;
e) determining a flow rate of the provided water; and
f) calculating an extract dilution ratio according to: Extract Dilution Ratio=Flow Rate×Run Time÷Input Weight.

20. The method of claim 19, further comprising adjusting the fixed rotational speed of the auger shaft to provide a desired value for the extract dilution ratio.
